(19) United States
(12) Patent Application Publication
(10) Pub. No.: US 2007/0140131 A1
(43) Pub. Date: Jun. 21, 2007

(54) Interactive network monitoring and analysis

(76) Inventors: Patrick J. Malloy, Washington, DC (US); Alain Cohen, Washington, DC (US); Ryan Gehl, Silver Spring, MD (US); John Wilson Strohm, Rockville, MD (US); Russell Mark Elsner, Bethesda, MD (US)

Correspondence Address: ROBERT M. MCDERMOTT, ESQ., 1824 FEDERAL FARM ROAD, MONTROSS, VA, 22520, US

(21) Appl. No.: 11/639,863

(22) Filed: Dec. 15, 2006

Related U.S. Application Data
(60) Provisional application No. 60/750,667, filed on Dec. 15, 2005.
(60) Provisional application No. 60/773,563, filed on Feb. 15, 2006.

(51) Int. Cl. H04L 12/26

(52) U.S. Cl. 370/241

(57) ABSTRACT

A network monitoring system and method processes captured message data to create a plurality of categories, provides summary data corresponding to each category, and displays the categorized summary data. The categories preferably include an identification of the source node and destination node of each message, and the summary data includes the amount of traffic communicated between each pair of nodes. The display of this summary data includes a graphic display that provides a visual indication of each pair and the volume of traffic between the nodes of the pair.

This application claims the benefit of U.S. Provisional Patent Application 60/750,667, filed 15 Dec. 2005 and U.S. Provisional Patent Application 60/773,563, filed 15 Feb. 2006.

### BACKGROUND AND SUMMARY OF THE INVENTION

This invention relates to the field of network management, and in particular to an interactive system and method for capturing and analyzing network traffic.

The complexities of network managing continue to increase, along with the corresponding need for efficient and effective network monitoring to detect and troubleshoot problems, or potential problems.

A variety of tools are available for capturing network traffic, including, for example, discrete hardware devices termed ‘network sniffers’ that monitor traffic on selected channels, and software modules that are embedded within routers or other network switching systems. Generally, these tools are configured to record a portion of the contents of each message that is communicated over the channel(s) being monitored. Depending upon the capabilities of the tool, some filtering may be applied based on contents of the message, to selectively record only the information related to particular messages or particular types of messages.

Network monitoring tools had conventionally been used to create a record of network traffic to facilitate fault analysis and/or fault isolation when a problem was detected or suspected. These monitoring tools had also conventionally been used to characterize traffic flow through the network to facilitate network modeling and simulation. As the need for rapid response and maximum ‘up-time’ has increased, these tools are being used to monitor network traffic in a more active manner, to potentially recognize problems as they are developing, before they lead to outages or other failures.

Although the available tools are effective for recording information related to each monitored message, the sheer volume of messages over a monitored channel reduces the tool's effectiveness for on-line, or real-time, analysis. U.S. patent applications 2004/0093413, 2004/0098611, and 2004/0133733 filed 13 May 2004, 20 May 2004, and 8 Jul. 2004 for Bean et al. and incorporated by reference herein, disclose techniques for organizing captured network data to facilitate an interactive display of the volume of data communicated through a router over time. Summary information, in the form of histogram data, is stored for each defined time period, with pointers to the detailed message data corresponding to this histogram data. The user is provided options to pan and zoom through this volume data, including the ability to view multiple time lines at different time scales. Because this data is summarized as histogram data, these panning and zooming actions can be performed quickly.

Although the display of the volume of data flowing through a router over time can facilitate an analysis of traffic flow, it does not, per se, facilitate the analysis of traffic patterns, and additional analysis of the underlying detailed data is required to identify the causes of the traffic. That is, in the prior art systems such as taught by Bean et al., there is no distinction among the messages at the summary level, and therefore any analysis that is based on characteristics of the messages requires a subsequent analysis of the underlying detailed data.

It would be advantageous to organize captured message traffic by categories, to facilitate real-time data-capture control and analysis based on such categorization. It would be advantageous if such categorization distinguished among the sources and/or destinations of the messages. It would also be advantageous if a user were able to customize and control the data capture tools while performing this network traffic analysis.

These advantages, and others, can be realized by a network monitoring system and method for processing captured message data to create a plurality of categories, providing summary data corresponding to each category, and displaying the categorized summary data. The categories preferably include an identification of the source node and destination node of each message, and the summary data includes the amount of traffic communicated between each pair of source-destination nodes. The display of this summary data includes a graphic display that provides a visual indication of each pair and the volume of traffic between the nodes of the pair.

### BRIEF DESCRIPTION OF THE DRAWINGS

The invention is explained in further detail, and by way of example, with reference to the accompanying drawings wherein:

FIG. 1 illustrates an example monitoring system for an example network of nodes and routers.

FIGS. 2A-2B illustrate an example interface of a monitoring system for creating and enabling agents that control the capture of message data.

FIG. 3A illustrates an example tier-circle graphic display of categorized summary traffic flow information in accordance with this invention.

FIGS. 3B and 3C illustrate example geographical display of categorized summary traffic flow information in accordance with this invention.

FIGS. 4A and 4B illustrates an example user interface for controlling the display of summary traffic flow information in a network monitoring system in accordance with this invention.

FIG. 5A illustrates an example block diagram of a network monitoring system in accordance with this invention, and FIG. 5B illustrates an example data structure for use in such a system.

Throughout the drawings, the same reference numerals indicate similar or corresponding features or functions. The drawings are included for illustrative purposes and are not intended to limit the scope of the invention.

### DETAILED DESCRIPTION

In the following description, for purposes of explanation rather than limitation, specific details are set forth such as the particular architecture, interfaces, techniques, etc., in order to provide a thorough understanding of the concepts of the invention. However, it will be apparent to those skilled in the art that the present invention may be practiced in other embodiments, which depart from these specific details. In like manner, the text of this description is directed to the example embodiments as illustrated in the Figures, and is not intended to limit the claimed invention beyond the limits expressly included in the claims. For purposes of simplicity and clarity, detailed descriptions of well-known devices, circuits, and methods are omitted so as not to obscure the description of the present invention with unnecessary detail.

The invention is presented herein using the generic term of ‘message’ to identify a communication from a source node of a network to one or more destination nodes. Depending upon the technologies used within the network, and within the collection tools, a message may be a discrete unit, such as a packet or frame, a set of discrete units, a continuous stream of finite length, or any other identifiable segments or sets of segments of related data items sent by the source node.

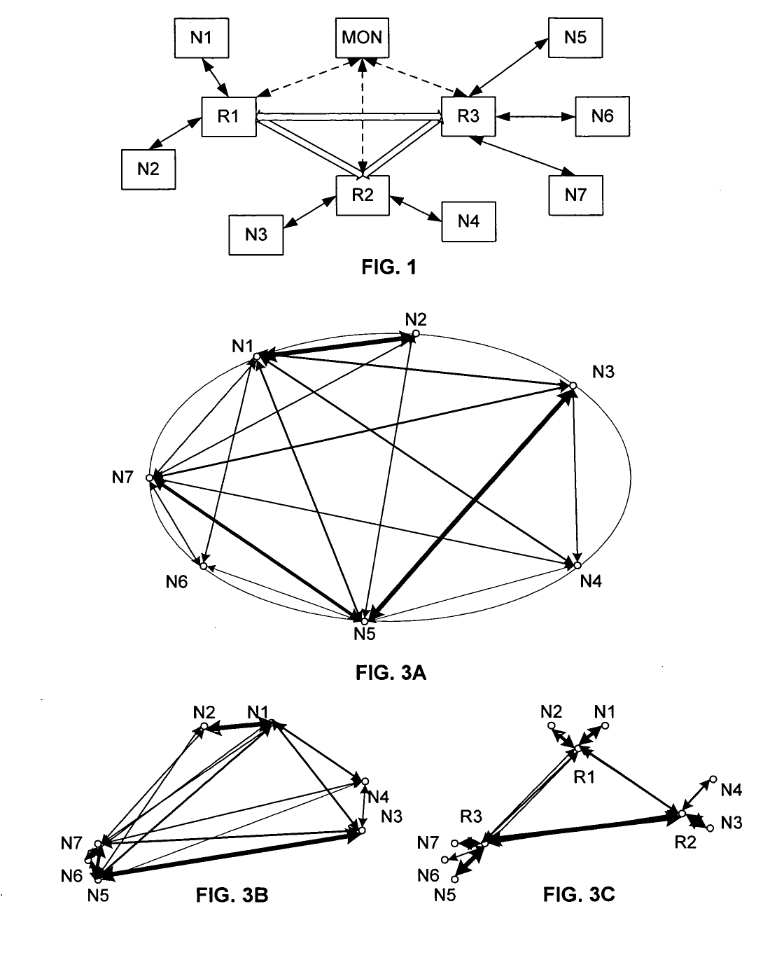

FIG. 1 illustrates an example network of nodes N1, N2, . . . N7 and routers R1, R2, R3, and a monitoring system MON that is configured to collect data from traffic monitoring tools situated at selected locations on the network. Typically, monitors are placed at routers, to capture a maximum amount of traffic data per monitor.

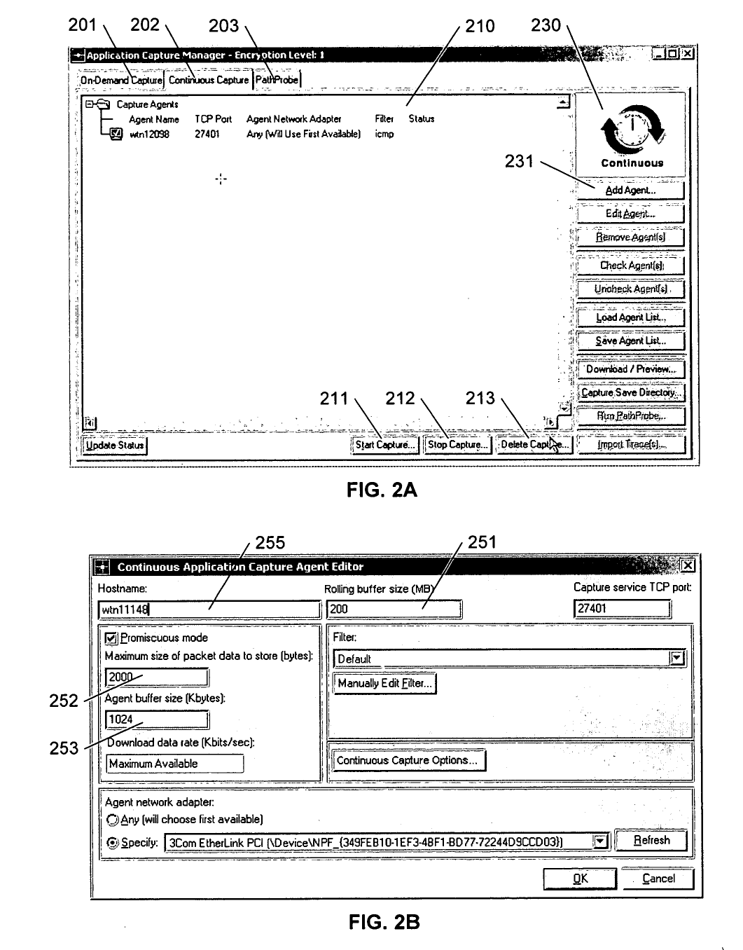

FIGS. 2A and 2B illustrate example interfaces of a monitoring system for managing network monitors.

The interface at FIG. 2A includes three tabs: “On-Demand Capture” 201, “Continuous Capture” 202, and “Path Probe” 203; the window 210 associated with Continuous Capture 202 being displayed. Within the window of each tab, the user is presented a list of currently available capture agents; an agent being the program used to control the network monitors. Upon selection of an agent, a designated capture associated with the agent can be started, stopped, or deleted using the corresponding buttons 211, 212, and 213.

The window 230 at the right of FIG. 2A provides options for creating and manipulating agents. When the “Add agent” button 231 is selected, the window of FIG. 2B is displayed. A continuous capture agent, as the name implies, continuously captures the message data. Typically, a large rolling buffer is used to record the most recent message data, the newest data continuously replacing the oldest data. The buffer size 251 determines how many most-recent message data items can be stored. Because the flow of messages can fluctuate significantly during a capture, the time-span associated with a particular buffer size can also vary greatly. For example, 200 megabytes of data could represent several minutes of heavy traffic or several hours of very light traffic. As illustrated in FIG. 2B, a variety of options are provided for controlling the data capture, including limiting how much of the message data to record 252, the size of the agent's buffer 253, and so on. When the user completes the entries for the agent, the information is saved using the hostname 255, and thereafter the agent name will appear in the window 210 of FIG. 2A for activation by the user.

As each agent captures the message data, the agent extracts information from each message, typically from the header information, and processes the information so as to create categorized summary data. In a preferred embodiment, the source and destination of each message is extracted, so that the message data can be categorized as a function of one or the other, or both. A particularly effective categorization uses tier-pairs, each pair corresponding to the source and destination nodes of a message, without regard to which node is source or destination; i.e. without regard to the direction of traffic flow. That is, for example, messages associated with the tier-pair N1-N4 of FIG. 1 include messages from N1 to N4, as well as messages from N4 to N1. In addition, or alternatively, other message data, such as an identification of the port, the protocol, or other parameter may be stored.

The monitoring system MON receives the categorized summary data from one or more of the network monitors, and displays it in one or more formats. As a summarization of the message data, the summary data is generally much smaller in size than the raw message data. Accordingly, transferring the summary data from the network monitors to the monitoring system advantageously takes significantly less time than transferring the raw message data, thereby enabling a user to more quickly analyze a given set of network traffic.

FIG. 3A illustrates an example display of summary data categorized by tier-pairs. Each node of the network is represented by a point on the perimeter of a circular shape, and each tier-pair is represented by a chord between the corresponding points. The summary data associated with the tier-pair includes the amount of data communicated between the nodes of each pair, and can be represented on the tier-pair circle in any of a variety of ways. In FIG. 3A, the amount of data for each tier pair is represented by the thickness of each chord corresponding to the pair. Alternatively, or additionally, colors can be used to indicate different amounts, text boxes can be placed on each chord, and so on. In the example of FIG. 3A, tier-pair N1-N2 is illustrated as having substantially more traffic than, for example, tier-pair N1-N6.

FIGS. 3B and 3C illustrate alternative formats for the display of the summary data. In this format, geographic information associated with each node is used to determine the location of each node on the display. In FIG. 3B, the traffic is represented for each tier-pair, as in FIG. 3A. In FIG. 3C, the summary data includes an identification of the path of each message through the routers R1, R2, R3, and the display indicates the amount of data on each link of the network.

One of ordinary skill in the art will recognize that many alternative display formats may be used for a given set of categories, and that alternative sets of categories may be used to create different organizations of summary data. For example, the same data that is used to generate the display of FIG. 3A can be used to provide a bar-chart indicating the amount of traffic for each tier pair, or the amount of data for each individual node, and so on. Similarly, the displays may be configured to distinguish between the amount of data transmitted and received, between original transmissions and re-transmissions, and so on.

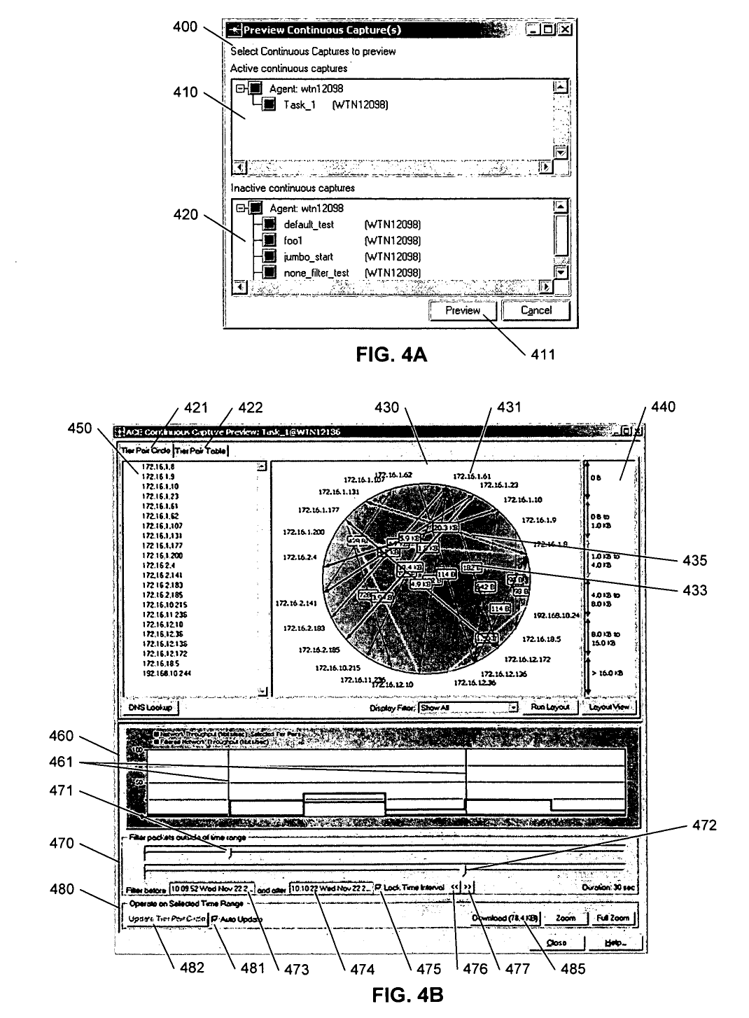

FIGS. 4A and 4B illustrate example views of a user interface for controlling the display of the summary data related to message data in accordance with this invention.

In FIG. 4A, the user is provided a dialog box 400 for selecting the message data to be analyzed, wherein the message data is organized according to the capture agent with which the message data was captured. The user can choose from among any of the active continuous captures in window 410 or inactive continuous captures in window 420. The active continuous captures are those that have previously been started, using, for example, the interface of FIG. 2A, and are constantly updated as new data is captured. The inactive continuous captures are those that have previously been stopped, also using the interface of FIG. 2A, and comprise a store of captured data that remains static until the continuous capture is restarted. A particular capture is selected for analysis by clicking the associated entry and selecting the preview button 411.

In FIG. 4B, the summary data associated with the selected capture(s) is displayed. At the upper section of the display, tabs “Tier-Pair Circle” 421 and “Tier-Pair Table” 422 are provided to allow the user to select different views. Other tabs may be provided to display the same information in alternative forms, such as the geographic formats of FIGS. 3B and 3C.

The tab “Tier-Pair Circle” 421 is illustrated as having been selected in FIG. 4B, resulting in the illustrated upper display windows 430, 440, 450. The tier-pair circle window 430 includes the identifiers of the nodes 431 arranged about the perimeter of the a circle 432, and the amount of traffic between each pair of nodes is indicated by chords with text boxes 433 that indicate the amount, or rate, of traffic flow for a given time period. In this example embodiment, color is also used to indicate the amount of traffic, and a legend window 440 displays the range of traffic corresponding to each different color. The window 450 provides a list of the identifiers of each node, and is synchronized with the tier-circle window 430, so that a selection of a node identifier in window 450 causes that node to be highlighted in the tier-circle window 430. Other options are also provided, including the highlighting of one or more tier-pair chords in the tier-circle window 430 when multiple nodes are selected in window 450.

A selection of the Tier-Pair Table tab 422 will effect the display of the same data in a tabular form, as a list of each tier-pair and the corresponding amount of traffic for the pair, in either text or bar-graph form. Optionally, a matrix of tiers can be displayed, in which some or all of the tiers are listed on both the horizontal and vertical axis, and the intersecting box for any two tiers will identify the corresponding amount of traffic between those tiers.

The window 460 provides a timing diagram of the amount of traffic data over time. The example window 460 illustrates the traffic flow for the entire network and any selected tier pairs. For example, if a tier-pair chord 435, or a group of tier-pair chords is selected in window 430, the window 460 will display the traffic flow for that particular selection in conjunction with the traffic flow for the entire network. The two flows are preferably distinguished via different colors, but could alternatively be distinguished using different line styles (e.g. dotted, dashed, etc.). In an alternative embodiment, if multiple tier-pair chords are selected, each corresponding traffic flow is displayed separately using a variety of colors or line styles. In another alternative embodiment, multiple windows 460 are displayed simultaneously, such that each window displays a separate data flow. Other options may also be provided, including, for example, displaying the traffic flow among the N most active nodes or tier-pairs.

Using conventional graphic interface techniques, the user can control the content of each window 460 by creating a zoom-box about a segment of the displayed timing diagram. In response, the monitoring system expands the selected segment across the span of the window 460, and redisplays the summary data with additional detail. Alternatively, an explicit timespan-control window 470 can be used to select the start and end times of the displayed information. In this window, the entire time-span of summary data is displayed, and a start-time slide pointer 471 and an end-time slide pointer 472 allow the user to zoom into selected times of the summary data. Optional text-input windows 473, 474 are also provided to facilitate this selection. This window 470 is preferably linked to a timing window 460 that is configured to display the total network traffic, and ‘goalpost’ lines 461 or other indicators are used to identify the selected time-span relative to the entire time-span of the summary data.

If the selected time-span is locked 475, the length of the time-span, or the distance between the goalposts 461, is fixed, and changing either the start time or stop time changes the other. In a preferred embodiment, when the time-span is locked 475, backward button 476 and forward button 477 appear, thereby enabling the user to step through the entire time-span at intervals equal to the amount of time between the goalposts 461. For example, if the time-span is locked and the selected duration of time is 20 seconds, any subsequent selection of the backward button 476 or forward button 477 will advance each of the slide pointers 471, 472, and consequently the goalposts 461, in the corresponding direction by 20 seconds.

Another control window 480 provides options for controlling the update of the summary data being displayed based on the selected time-span. If the auto-update option 481 is enabled, the tier-pair information displayed in the window 430 is automatically updated as the selected time-span is changed. Otherwise, the updating can be manually controlled, using the update button 482. The download option 485 allows the user to download from the network monitor only the detailed message data that corresponds to the time interval indicated by the goalposts. This advantageously eliminates the extra and often lengthy amount of time it would take to download all of the message data. The downloaded message data of interest can subsequently be analyzed in further detail with a network traffic analysis tool.

As noted above, the summary data can be selected from both active and inactive captures. In the event that an active capture is selected, the invention can be configured to continually collect new summary data from the capture agent so that analysis occurs in real-time. If, for example, the capture agent is configured to write summary data every 10 seconds, the system may be configured to check for new data every 10 seconds. A manual refresh button may also be provided to control window 480 to enable the user to choose when to display any newly received summary data, or to specify how frequently the display is to be refreshed.

In a preferred embodiment, the user is provided the option of applying one or more other filters to the summary data, including, for example, filters based on protocol, direction, packet size, application, abnormalities, and so on. Generally, select filter parameters are saved in files, and the user is provided the option of selecting one or more filter files to be applied to the summary data that is displayed. These filters, if so desired, can also be applied to any message data that is downloaded with the download option 485. The filters advantageously provide the user with a further mechanism for eliminating uninteresting traffic and reducing the time it takes to download message data needed for further analysis.

The user is also given the option of modifying the capture agents to collect different information based on the analysis of the summary data. For example, based on an initial analysis, the user may configure the capture agents to report the summary data more or less frequently, to achieve more or less resolution, or may configure the capture agents to capture message data from other tier-pairs, and so on.

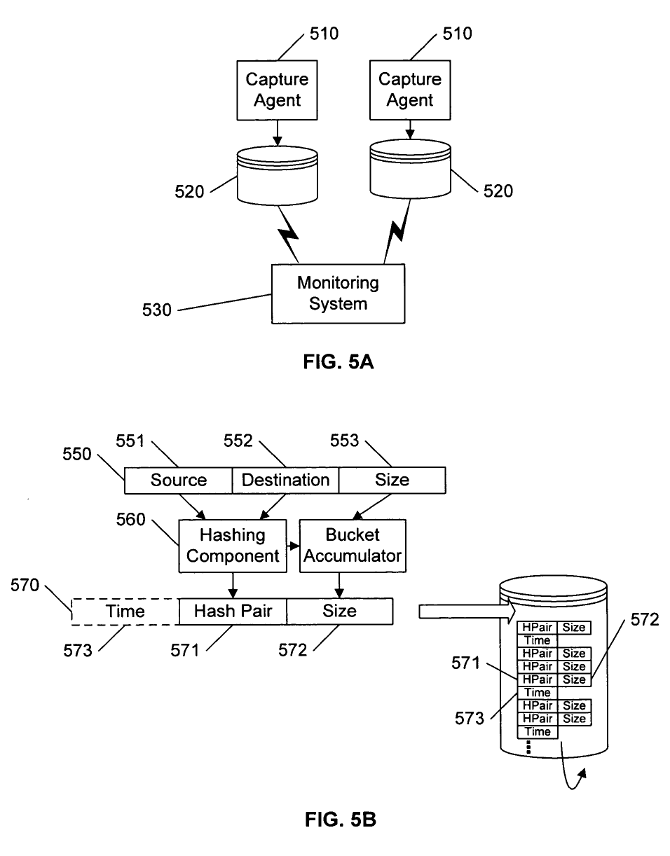

FIG. 5A illustrates an example block diagram of a network monitoring system, and FIG. 5B illustrates an example database scheme that facilitates efficient processing of message data in a network monitoring system.

The capture agents 510 are configured to capture message data and store it in a local data store 520, wherein data store 520 could be a traditional database, a file, computer-readable memory, or any other well-known data storage mechanism. As the message data is captured, the capture agents 510 are preferably configured to process the message data and generate summary data. The summary data may also be stored in the local data store 520, but it can alternatively be transmitted directly to the monitoring system 530. Correspondingly, the monitoring system 530 is configured to access the data stores 520 to retrieve the summary data, or receive the summary data directly. The monitoring system is also preferably configured to provide access to the captured message data at the data store 520 upon demand.

As noted above, the summary data that is provided to the monitoring system is categorized according to one or more properties of the network traffic, and the monitoring system 530 is configured to process and present this summary data based on this categorization. As also noted above, categorization by tier-pair has been found to be particularly well suited for traffic analysis and other purposes. FIG. 5B illustrates a technique for efficiently storing summary data that facilitates monitoring on a tier-pair basis.

In this example embodiment, elements 551-553 that are typically found in the header 550 of each message are processed to provide summary data 570 that facilitates display and analysis via the monitoring system 530. The source 551 and destination 552 of each message are provided to a hashing component 560 to provide a hash value 571 that identifies the pair of source-destination nodes, without regard to which node is the source and which node is the destination, each source-destination pair being termed a tier-pair herein. For example, if the hash value 571 is based on a product of the addresses of the source and destination nodes, the same product will result regardless of which node of the pair is the source 551 and which node is the destination 552. The hashing component 560 maintains a table for mapping the hash value 571 back to the tier-pair, which is used when displaying the associated summary data.

An accumulator 565 is preferably provided to accumulate the size of each message associated with each source-destination pair during a specified time period. Using conventional terminology, a “bucket” is associated with each tier-pair, and this bucket is used to accumulate a measure 572 of the amount of data transferred by the tier-pair within each user-definable collection period.

The record of the amount of data (accumulated-size) 572 transferred by each tier-pair for each time period 573 is stored in the local data store 520 associated with each capture agent 510, or alternatively transferred directly to the monitoring system 530 as discussed above. The time 573 may be stored with each hash value 571 and accumulated-size data entry 572, or, in a preferred embodiment, a single time 573 is assigned to all hash values 571 associated with a non-zero accumulated size 572 during this identified time period 573.

As noted above, other message data, such as the port or protocol used to transfer the data, or other parameter, may be included in the summary data 570 that is captured by each agent 510, or each set of agents. These other parameters may be saved as discrete data entries, or included within the computed hash value 571 that uniquely identifies the particular combination of parameters that serve to classify or categorize the captured message data. It should be recognized that hash values 171 are used as an efficiency mechanism and are not required to effectively store the message data. In other words, the source 551, destination 552, size 553 and a corresponding time period could be written to the data store 520 in its original format.

The foregoing merely illustrates the principles of the invention. It will thus be appreciated that those skilled in the art will be able to devise various arrangements which, although not explicitly described or shown herein, embody the principles of the invention and are thus within its spirit and scope. For example, although the processing of the message data 550 to provide summary data 570 that facilitates display of the data is preferably provided by the capture agents 510, to optimize storage space requirements, one of skill in the art will recognize that the raw data 550 for each message may alternatively be initially stored at and/or subsequently processed by an intermediary device to provide the summary data 570. These and other system configuration and optimization features will be evident to one of ordinary skill in the art in view of this disclosure, and are included within the scope of the following claims.

In interpreting these claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) each of the disclosed elements may be comprised of hardware portions (e.g., including discrete and integrated electronic circuitry), software portions (e.g., computer programming), and any combination thereof;
f) hardware portions may be comprised of one or both of analog and digital portions;
g) any of the disclosed devices or portions thereof may be combined together or separated into further portions unless specifically stated otherwise;
h) no specific sequence of acts is intended to be required unless specifically indicated; and
i) the term “plurality of” an element includes two or more of the claimed element, and does not imply any particular range of number of elements; that is, a plurality of elements can be as few as two elements, and can include an immeasurable number of elements.

We claim:

1. A network monitoring system, comprising:
a memory that is configured to store message data corresponding to communications among a plurality of nodes of a network,
a processor that is configured to process the message data to create one or more categories of the message data and to provide summary data corresponding to each category, and
a user interface that is configured to provide a graphic display of the summary data corresponding to the one or more categories.

2. The system of claim 1, wherein the one or more categories correspond to pairs of nodes of the plurality of nodes.

3. The system of claim 2, wherein the summary data corresponds to an amount of traffic communicated between nodes of each pair of nodes.

4. The system of claim 3, wherein the summary data includes a time parameter associated with the traffic communicated between the nodes.

5. The system of claim 4, wherein the graphic display includes a display of the amount of traffic relative to the time parameter associated with the traffic.

6. The system of claim 2, wherein the graphic display includes a tier circle, wherein each node is identified as a point on a perimeter of the tier circle, and each pair is identified as a chord between the points on the perimeter corresponding to the nodes of the pair.

7. The system of claim 6, wherein the graphic display of one or more of the chords includes an indication of the summary data of the pair corresponding to each chord.

8. The system of claim 7, wherein the summary data corresponds to an amount of traffic communicated between nodes of each pair of nodes.

9. The system of claim 7, wherein the user interface is configured to facilitate selection of a select chord, and to display additional information related to traffic communicated between the nodes corresponding to the select chord.

10. The system of claim 9, wherein the summary data corresponds to an amount of traffic communicated between nodes of each pair of nodes, and a time parameter associated with the traffic communicated between the nodes.

11. The system of claim 10, wherein the additional information includes an amount of traffic communicated between the nodes of the pair displayed relative to the time parameter associated with the traffic.

12. The system of claim 11, wherein:
the memory is configured to be updated with new message data on a continuing basis,
the processor is configured to process the new message data while the graphic display is being provided to provide new summary data, and
the user interface is configured to facilitate graphic display of the new summary data.

13. The system of claim 12, wherein the user interface is configured to facilitate an automatic display of the new summary data.

14. The system of claim 1, wherein:
the memory is configured to be updated with new message data on a continuing basis,
the processor is configured to process the new message data while the graphic display is being provided to provide new summary data, and
the user interface is configured to facilitate graphic display of the new summary data.

15. The system of claim 14, wherein the user interface is configured to facilitate an automatic display of the new summary data.

16. The system of claim 14, wherein:
the summary data includes a time parameter, and
the graphic display includes a timing diagram based on the time parameter.

17. The system of claim 1, wherein:
the summary data includes a time parameter, and
the graphic display includes a timing diagram based on the time parameter.

18. The system of claim 1, wherein the message data includes an accumulation of data associated with multiple messages.

19. The system of claim 1, wherein the message data includes an accumulation of data associated with multiple sources and destinations.

20. The system of claim 1, wherein the graphic display includes a histogram.

21. The system of claim 1, wherein the graphic display includes a matrix.

22. The system of claim 1, wherein the graphic display includes a plurality of colors, each color corresponding to a range of values of the summary data.

23. The system of claim 1, wherein:
the summary data includes a time parameter, and
the user interface is configured to facilitate selection of a time range of the graphic display.

24. The system of claim 23, wherein the user interface is configured to facilitate receiving the message data corresponding to a selected time range.

25. The system of claim 23, wherein the user interface is configured to facilitate selection of a time scale of the graphic display.

26. The system of claim 25, wherein the user interface is configured to facilitate incremental adjustment of the time range while maintaining a constant time scale.

27. The system of claim 1, wherein:
the user interface is configured to facilitate selection of one or more filters, and
the processor is configured to filter the summary data based on the selection of the one or more filters.

28. The system of claim 27, wherein the processor is configured to receive and filter the message data based on the selection of the one or more filters.

29. The system of claim 27, wherein the one or more filters include one or more of:
a protocol filter,
a direction filter,
a message size filter,
an application filter, and
an abnormal event filter.

30. The system of claim 1, wherein the user interface is configured to facilitate control of one or more capture agents that provide the message data to the memory.

31. The system of claim 30, including the one or more capture agents.

32. The system of claim 1, wherein the summary data includes a hashed value based on one or more parameters associated with the communications among the plurality of nodes.

33. The system of claim 32, wherein the one or more parameters include a source address and a destination address.

34. The system of claim 33, wherein a given pair of source and destination addresses provides a particular hashed value, independent of which address of the pair is the source address and which address of the pair is the destination address.

35. The system of claim 1, wherein:
the graphic display includes a plurality of display regions, and
at least a portion of the summary data is provided in each of at least two display regions, in different forms.

36. The system of claim 35, wherein the user interface is configured to enable selection of the portion in a first display region to effect display of the portion in a second display region.

37. The system of claim 35, wherein:
the categories correspond to pairs of nodes of the plurality of nodes,
the summary data corresponds to an amount of traffic communicated between nodes of each pair of nodes.

38. The system of claim 37, wherein the different forms include:
a first form that illustrates the amount of traffic as a single entity, and
a second form that illustrates the amount of traffic as a function of time.

39. The system of claim 38, wherein the first form includes a tier-pair circle, in which each node is identified as a point on a perimeter of the tier circle, and each pair is identified as a chord between the points on the perimeter corresponding to the nodes of the pair.

40. The system of claim 38, wherein the amount of traffic is illustrated by a color of the chord.

41. The system of claim 38, wherein:
the first form includes a histogram,
each pair being identified as an ordinate of an axis of the histogram, and
the amount of traffic of each pair corresponding to a length of a bar of the histogram.

42. The system of claim 38, wherein:
the first form includes a matrix,
each pair being identified as coordinates of the matrix, and
the amount of traffic of each pair corresponding to a value of a cell of the matrix.

43. A method for analyzing network traffic, comprising:
storing message data corresponding to communications among a plurality of nodes of a network,
processing the message data to create a plurality of categories of the message data and to provide summary data corresponding to each category, and
displaying the summary data corresponding to the plurality of categories in a graphic display.

44. The method of claim 43, wherein the categories correspond to pairs of nodes of the plurality of nodes.

45. The method of claim 44, wherein the summary data corresponds to an amount of traffic communicated between nodes of each pair of nodes.

46. The method of claim 45, wherein the summary data includes a time parameter associated with the traffic communicated between the nodes.

47. The method of claim 46, wherein the graphic display includes a display of the amount of traffic relative to the time parameter associated with the traffic.

48. The method of claim 43, wherein the graphic display includes a tier circle, wherein each node is identified as a point on a perimeter of the tier circle, and each pair is identified as a chord between the points on the perimeter corresponding to the nodes of the pair.

49. The method of claim 48, wherein the graphic display of one or more of the chords includes an indication of the summary data of the pair corresponding to each chord.

50. The method of claim 49, wherein the summary data corresponds to an amount of traffic communicated between nodes of each pair of nodes.

51. The method of claim 49, including:
detecting selection of a chord, and
displaying additional information related to traffic communicated between the nodes corresponding to the select chord.

52. The method of claim 51, wherein the summary data corresponds to an amount of traffic communicated between nodes of each pair of nodes, and a time parameter associated with the traffic communicated between the nodes.

53. The method of claim 52, wherein the additional information includes an amount of traffic communicated between the nodes of the pair displayed relative to the time parameter associated with the traffic.

54. The method of claim 53, including:
storing new message data on a continuing basis,
processing the new message data while the graphic display is being provided to provide new summary data, and
displaying the new summary data on the graphic display.

55. The method of claim 54, including automatically displaying the new summary data.

56. The method of claim 43, including:
storing new message data on a continuing basis,
processing the new message data while the graphic display is being provided to provide new summary data, and
displaying in the graphic display the new summary data.

57. The method of claim 56, including automatically displaying the new summary data.

58. The method of claim 56, wherein:
the summary data includes a time parameter, and
the graphic display includes a timing diagram based on the time parameter.

59. The method of claim 43, wherein:
the summary data includes a time parameter, and
the graphic display includes a timing diagram based on the time parameter.

60. The method of claim 43, wherein the processing of the message data includes accumulating data associated with multiple messages.

61. The method of claim 43, wherein the message data includes an accumulation of data associated with multiple sources and destinations.

62. The method of claim 43, wherein the graphic display includes a histogram.

63. The method of claim 43, wherein the graphic display includes a matrix.

64. The method of claim 43, wherein the graphic display includes a plurality of colors, each color corresponding to a range of values of the summary data.

65. The method of claim 43, wherein the summary data includes a time parameter, and
the method includes modifying a time range of the graphic display based on a user input.

66. The method of claim 65, including downloading the message data corresponding to a selected time range.

67. The method of claim 65, including modifying a time scale of the graphic display based on a user input.

68. The method of claim 67, including incrementally adjusting the time range while maintaining a constant time scale.

69. The method-of claim 43, including:
detecting a selection of one or more filters, and
filtering the summary data based on the selection of the one or more filters.

70. The method of claim 69, including receiving and filtering the message data based on the selection of the one or more filters.

71. The method of claim 69, wherein the one or more filters include one or more of:
a protocol filter,
a direction filter,
a message size filter,
an application filter, and
an abnormal event filter.

72. The method of claim 43, including controlling, via the graphic display, one or more capture agents that provide the message data to the memory.

73. The method of claim 43, wherein the processing of the message data includes hashing one or more parameters associated with the communications among the plurality of nodes to provide a hashed value.

74. The method of claim 73, wherein the one or more parameters include a source address and a destination address.

75. The method of claim 74, wherein the hashing of a given pair of source and destination addresses provides a particular hashed value, independent of which address of the pair is the source address and which address of the pair is the destination address.

76. The method of claim 43, wherein:
the graphic display includes a plurality of display regions, and
the displaying of the summary data includes displaying at least a portion of the summary data in each of at least two display regions, in different forms.

77. The method of claim 76, including:
detecting a selection of the portion in a first display region, and
displaying the portion in a second display region.

78. The method of claim 76, wherein:
the categories correspond to pairs of nodes of the plurality of nodes,
the summary data corresponds to an amount of traffic communicated between nodes of each pair of nodes.

79. The method of claim 78, wherein the different forms include:
a first form that illustrates the amount of traffic as a single entity, and
a second form that illustrates the amount of traffic as a function of time.

80. The method of claim 79, wherein the first form includes a tier-pair circle for which each node is identified as a point on a perimeter of the tier circle, and each pair is identified as a chord between the points on the perimeter corresponding to the nodes of the pair.

81. The method of claim 80, wherein the amount of traffic is illustrated by a color of the chord.

82. The method of claim 81, wherein:
the first form includes a histogram,
each pair being identified as an ordinate of an axis of the histogram, and
the amount of traffic of each pair corresponding to a length of a bar of the histogram.

83. The method of claim 81, wherein:
the first form includes a matrix,
each pair being identified as coordinates of the matrix, and
the amount of traffic of each pair corresponding to a value of a cell of the matrix.
